(19) United States
(12) Patent Application Publication
(10) Pub. No.: US 2003/0052863 A1
(43) Pub. Date: Mar. 20, 2003

(54) Computer keyboard structure

(76) Inventor: Wen-Hung Hsia, Taichung (TW)

Correspondence Address: RABIN & BERDO, P.C., Suite 500, 1101 14th Street, N.W., Washington, DC, 20005, US

(21) Appl. No.: 09/955,127

(22) Filed: Sep. 19, 2001

(51) Int. Cl. G09G 5/00

(52) U.S. Cl. 345/168

(57) ABSTRACT

The present invention discloses a computer keyboard that changes the hard plastic surface of the press key of the traditional computer keyboard to a press key having color, soft, and elastic properties, and the colored soft elastic press keys are classified into several key groups, each has a different color. By means of the colored soft elastic press keys, it helps the beginners to learn the position of the press keys, while obtaining a more comfortable feeling about the colored press keys.

### BACKGROUND OF THE INVENTION

1. Field of the Invention

The present invention relates to a computer keyboard, more particularly to a keyboard having colored soft elastic press keys.

2. Description of the Related Art

In FIG. 1, it shows a traditional computer keyboard structure, which is made by hard plastic material. However, the current traditional computer keyboard gives a less comfortable feeling when it is in use, and the press keys are printed with English letter or Chinese suffiy that makes it difficult for the beginners to locate the key's position, and hence giving rise to a big problem on user's inputting and learning.

### SUMMARY OF THE INVENTION

The objective of this invention is to provide a computer keyboard with press keys that are colored around the perimeter of the press keys or on the top surface of the press keys on the keyboard and are made of a material with appropriate hardness; the press keys are classified into several groups, each group has a different color. By means of the colored soft elastic press keys, it helps the beginners quickly and relaxed to learn the position of the English letter or Chinese suffiy press keys, while obtaining a more comfortable and beautiful feeling about the colored press keys.

To make it easier for our examiner to understand the objective of the invention, its structure, innovative features, and its performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows a traditional computer keyboard.

FIG. 2 shows a three-dimensional structural diagram of the disassembled parts of the press key of the present invention.

FIG. 2-1 shows the cross-section of the structure of the press keys of the present invention as shown in FIG. 2.

FIG. 3 shows a three-dimensional structural diagram of the disassembled parts of the press key of another embodiment of the present invention.

FIG. 3-1 shows the cross-section of the structure of the press keys of the present invention as shown in FIG. 3.

FIG. 4 shows the planar layout of the press key position of the present invention.

FIG. 5 shows the position of the press key group of the computer keyboard which is made up of seven press keys representing seven English letters of “A, B, C, D, E, F, and G” of the present invention.

FIG. 6 shows the position of the press key group of the computer keyboard which is made up of seven press keys representing seven English letters of “H, I, J, K, L, M, N, O, and P” of the present invention.

FIG. 7 shows the position of the press key group of the computer keyboard which is made up of four press keys representing four English letters of “Q, R, S, and T” of the present invention.

FIG. 8 shows the position of the press key group of the computer keyboard which is made up of six press keys representing six English letters of “U, V, W, X, Y, and Z” of the present invention.

FIG. 9 shows the position of the press key group of the computer keyboard which is made up of seven press keys representing seven English letters of “H, I, J, K, L, M, and N” of the present invention.

FIG. 10 shows the position of the press key group of the computer keyboard which is made up of four press keys representing four English letters of “O, P, Q, and R” of the present invention.

FIG. 11 shows the position of the press key group of the computer keyboard which is made of six press keys representing six English letters of “S, T, U, V, W, and Y” of the present invention.

FIG. 12 shows the position of the press key group of the computer keyboard which is made up of two press keys representing two English letters of “Z and X” of the present invention.

FIG. 13 shows the position of the press key group of the computer keyboard, which is made up of a key representing an English letter of “U” of the present invention.

FIG. 14 shows the position of the press key group of the computer keyboard which is made up of three press keys representing three English letters of “V, W, and Y” of the present invention.

FIG. 15 shows the position of the press key group of the computer keyboard, which is made up of a press key representing an English letter of “Y” of the present invention.

FIG. 16 shows the position of the press key group of the computer keyboard, which is made up of a press key representing an English letter of “Z” of the present invention.

FIG. 17 shows the position of the partition line on the keyboard that divides the press keys into two jurisdiction areas for the input by left and right hands.

FIG. 18 shows the planar diagram of position layout for the English keyboard according to the present invention.

FIG. 19 shows the position of the partition line on the keyboard that divides the press keys into tow jurisdiction areas for the input by left and right hands according to another embodiment of the present invention

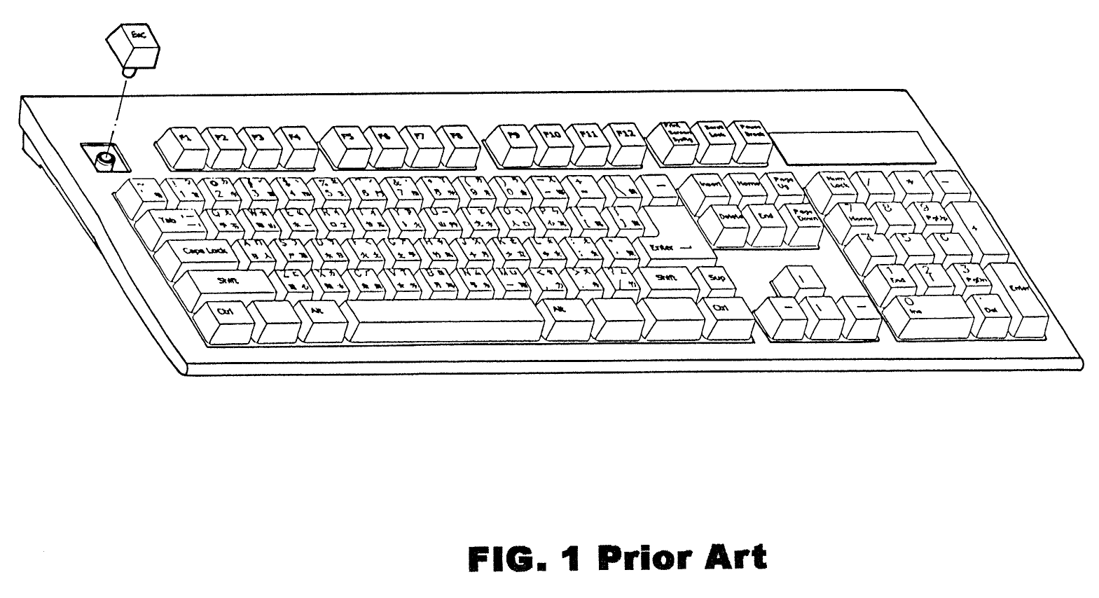

### DETAILED DESCRIPTION OF THE PREFERRED EMBODIMENTS

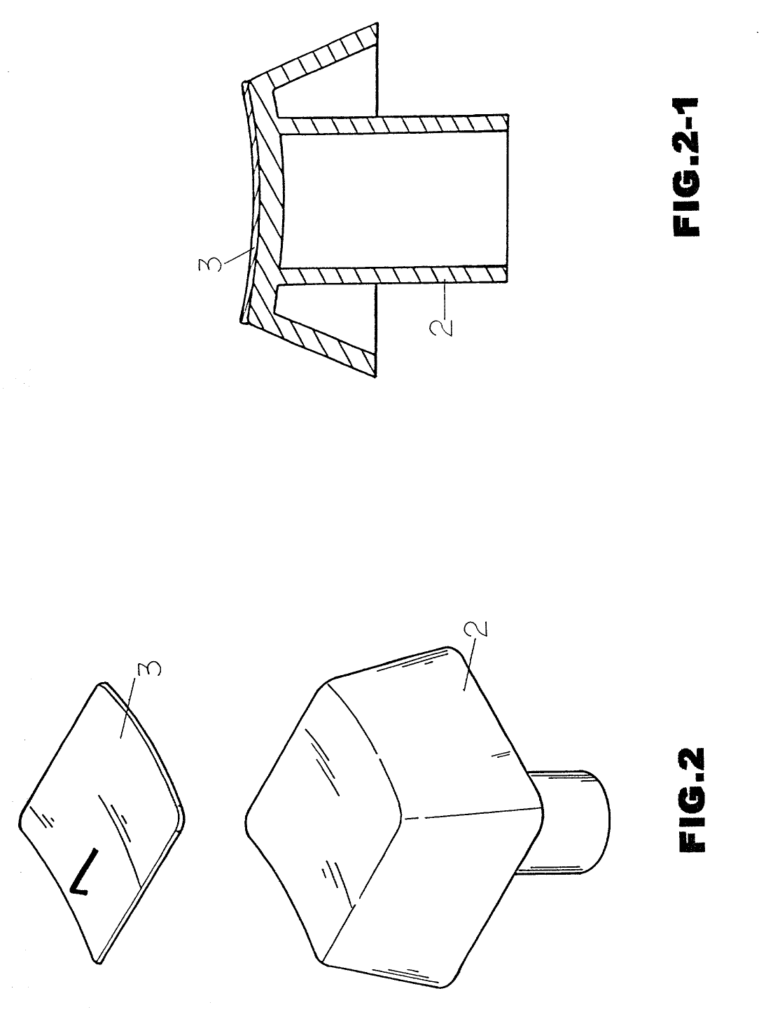

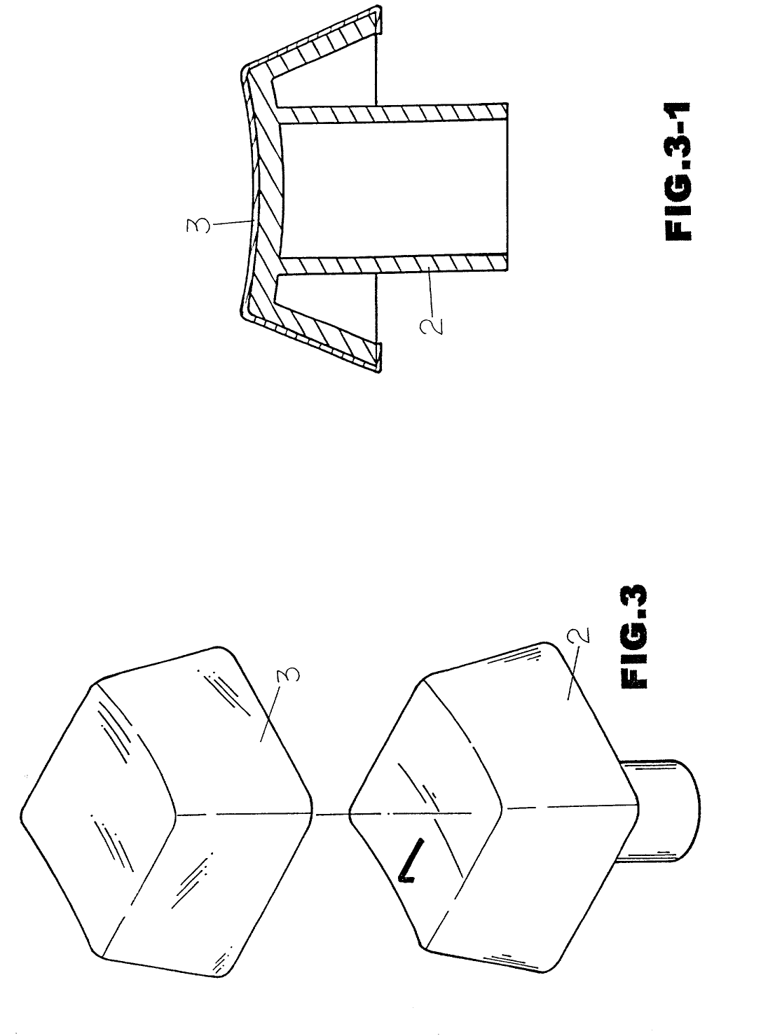

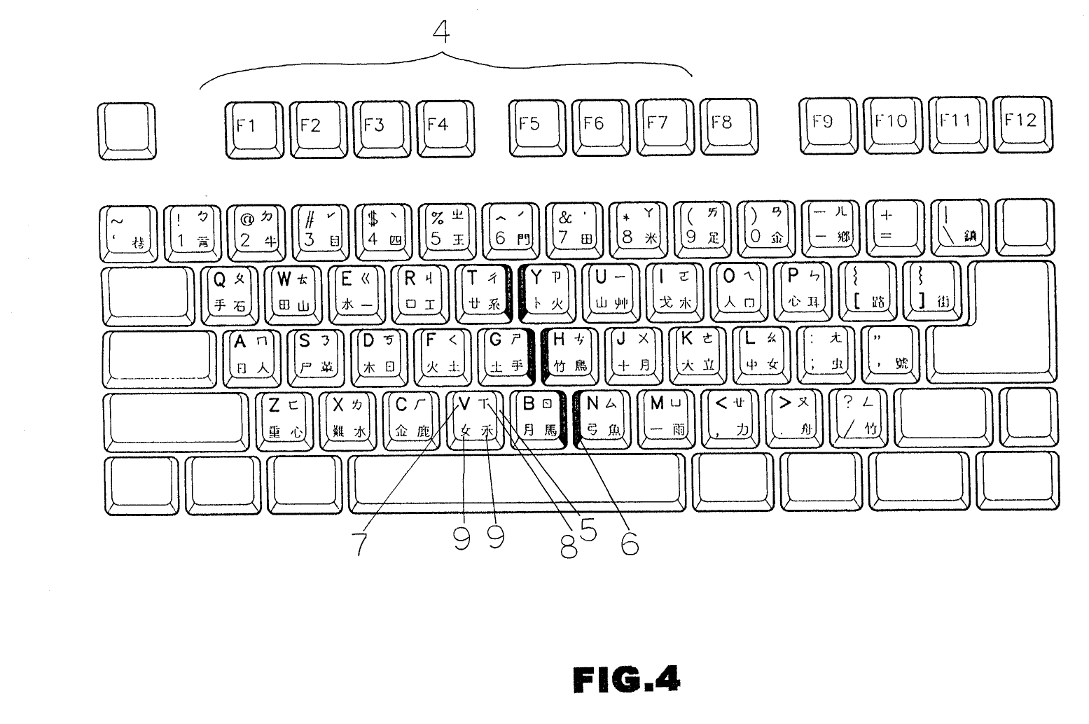

Please refer to FIGS. 2 to 16 and the brief description of the drawings. The computer keyboard structure of the present invention comprises a plurality of press keys being disposed and arranged in the predetermined position of the computer keyboard, and the surface of each press key has a text (such as English letter 7 conforming with the need for different countries to have, phonetic symbols 8, Chinese suffix 9) and symbols as shown in FIG. 4, wherein the press key (1) is integrally combined with the press key member (2) and a soft layer (3). The soft layer (3) can be selectively coupled to the top surface of the whole periphery surface, or even made in the transparent form or in a non-transparent form with predetermined colors. The press key member (2) complies with the soft layer (3) and it is made with determined color. In addition, the 26 letter keys on the keyboard (4) are divided into several key groups in order, and each group has a different color. Please refer to FIGS. 4 to 16 again and its attachments 1, 2 and 3. By means of the color allocation, it gives a better understanding about the position of each English letter key on the keyboard for beginners. Furthermore, the soft elastic press key (1) effectively prevents and reduces the possibility of the nerve ending at the finger tip from being damaged, and offers a press key structure with more comfortable input operation, and improves the learning and using efficiency and interest for beginners, which is definitely useful for the industry.

Furthermore, the above-mentioned press keys having the English letters of T, G, and B, and the corresponsive lateral side of that having the English letters of Y, H, and N are set to a predetermined color, say black, forming a partition line (6) which separates the key in area into left hand and right hand so that the beginners will not be confused with the left hand keys and the right hand keys, and further prevent making mistakes in typing as shown in FIG. 4.

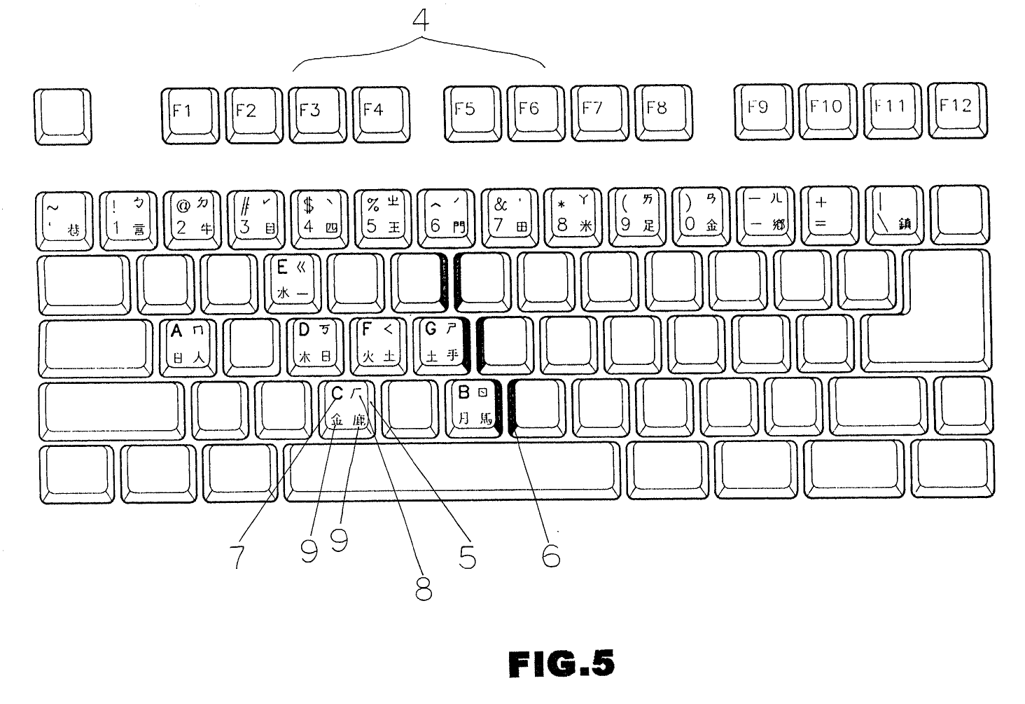

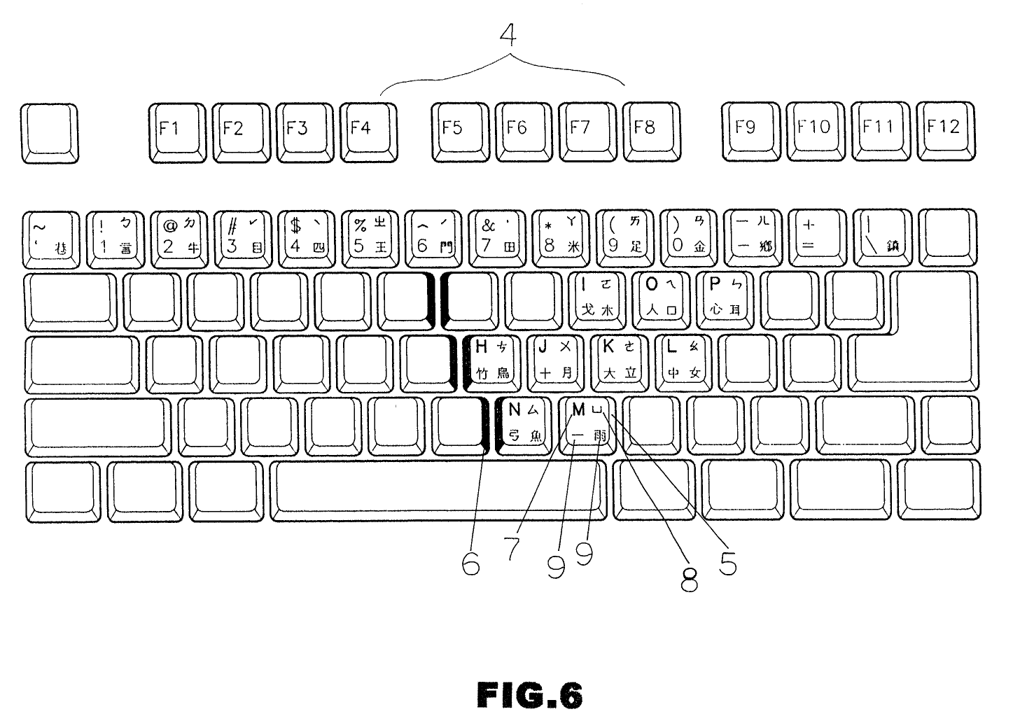

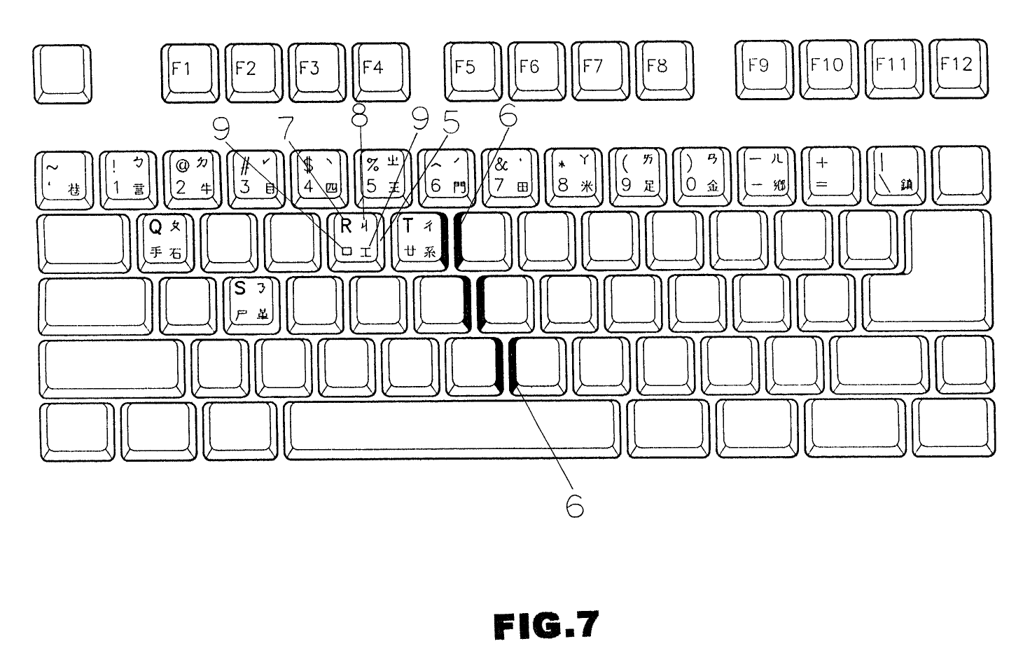

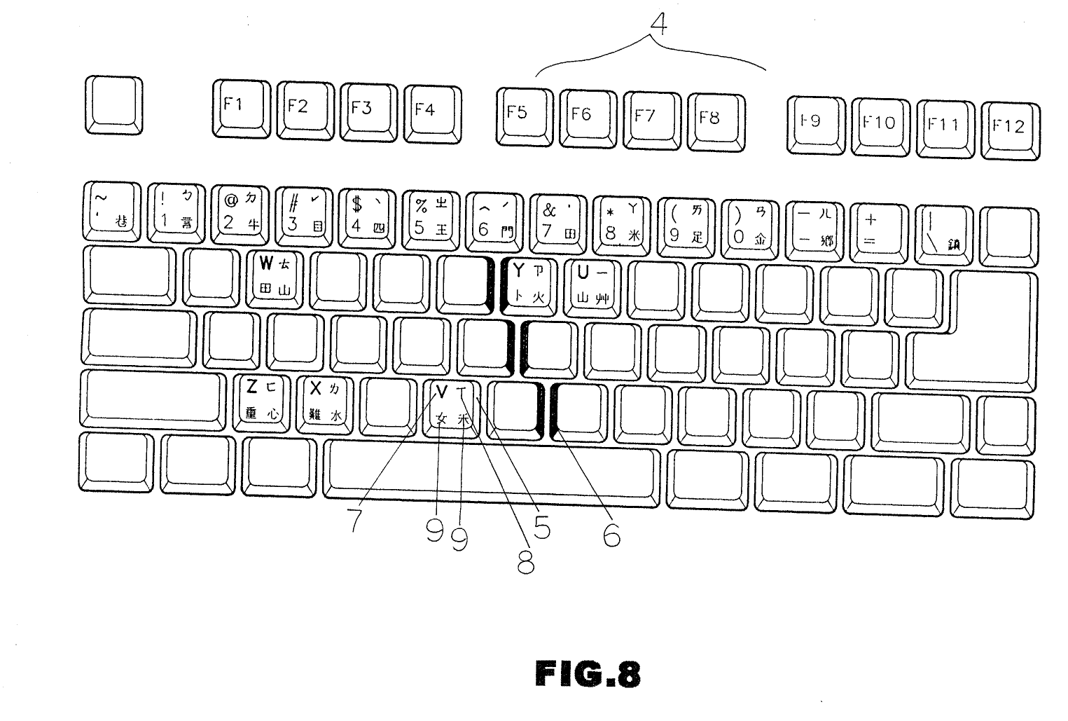

As mentioned before, the press keys of the twenty-six English letters are classified into several key groups (5), and each group has a different color. The present invention is designed to have three different types of keyboards (4). The first type of keyboards is divided into 4 key groups (5) as shown in the Attachment 1, grouping the seven English letters of “A, B, C, D, E, F, and G” as a group and arranging these seven keys with a same color (as shown in FIG. 5), the nine English letters of “H, I, J, K, L, M, N, O, and P” as another group with another color (as shown in FIG. 6), the four English letters of “Q, R, S, and T” as another group with another color (as shown in FIG. 7), and the six English letters of “U, V, W, X, Y, and Z” as another group with another color (as shown in FIG. 8).

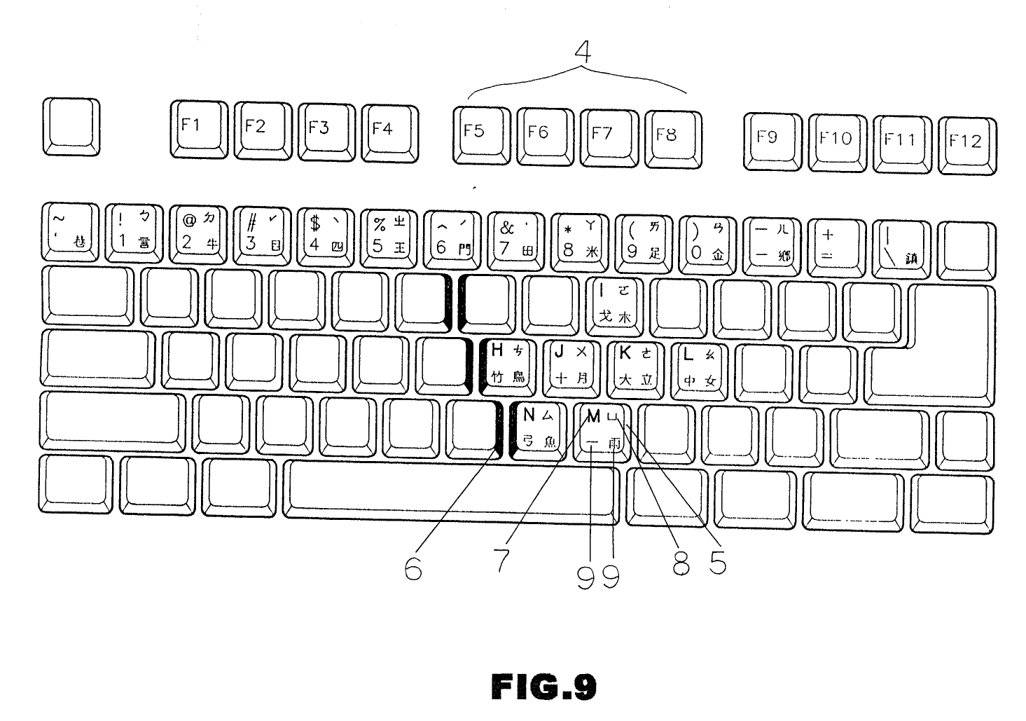

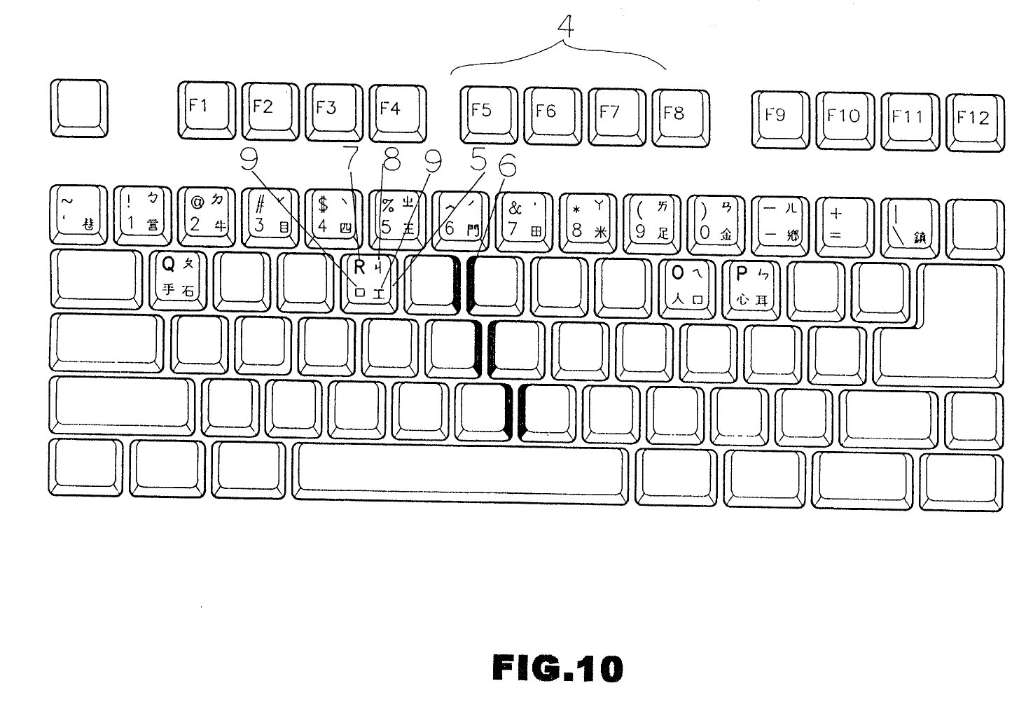

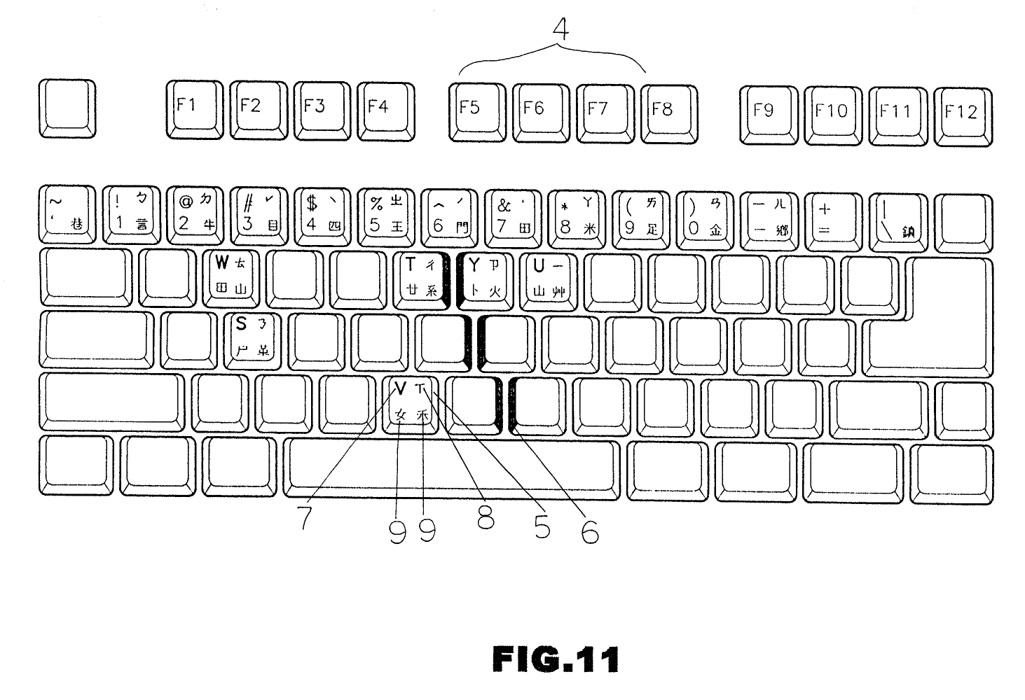

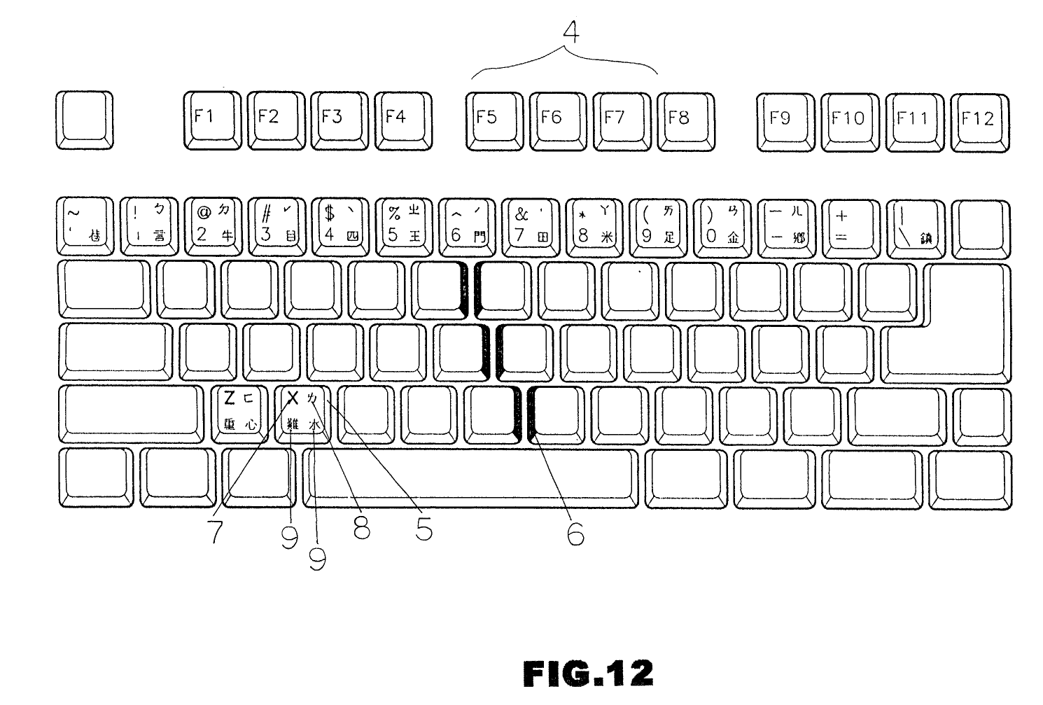

The second type of keyboards is divided into 5 key groups (5) as shown in Attachment 2, grouping the seven English letters of “A, B, C, D, E, F, and G” as a group and arranging these seven keys with a same color (as shown in FIG. 5), the seven English letters of “H, I, J, K, L, M, and N” as another group with another color (as shown in FIG. 9), the four English letters of “O, P, Q, and R,” as another group with another color (as shown in FIG. 10), the six English letters of “S, T, U, V, W, and Y” as another group with another color (as shown in FIG. 11), and the two English letters of “Z and X” as another group with another color (as shown in FIG. 12).

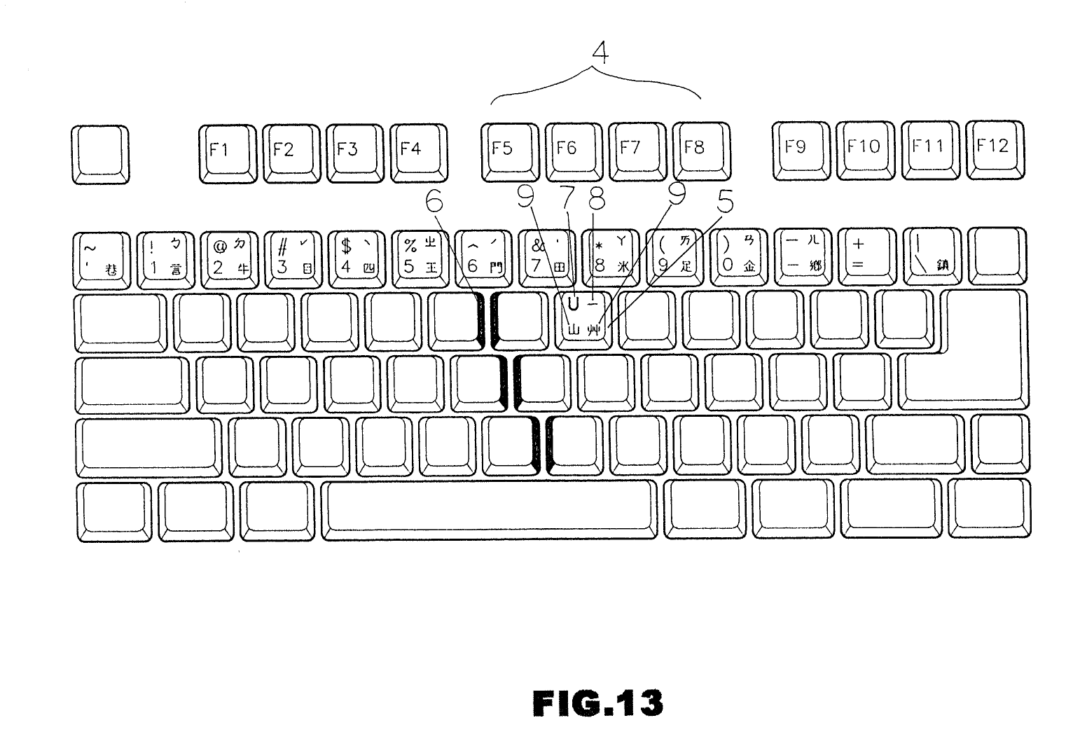

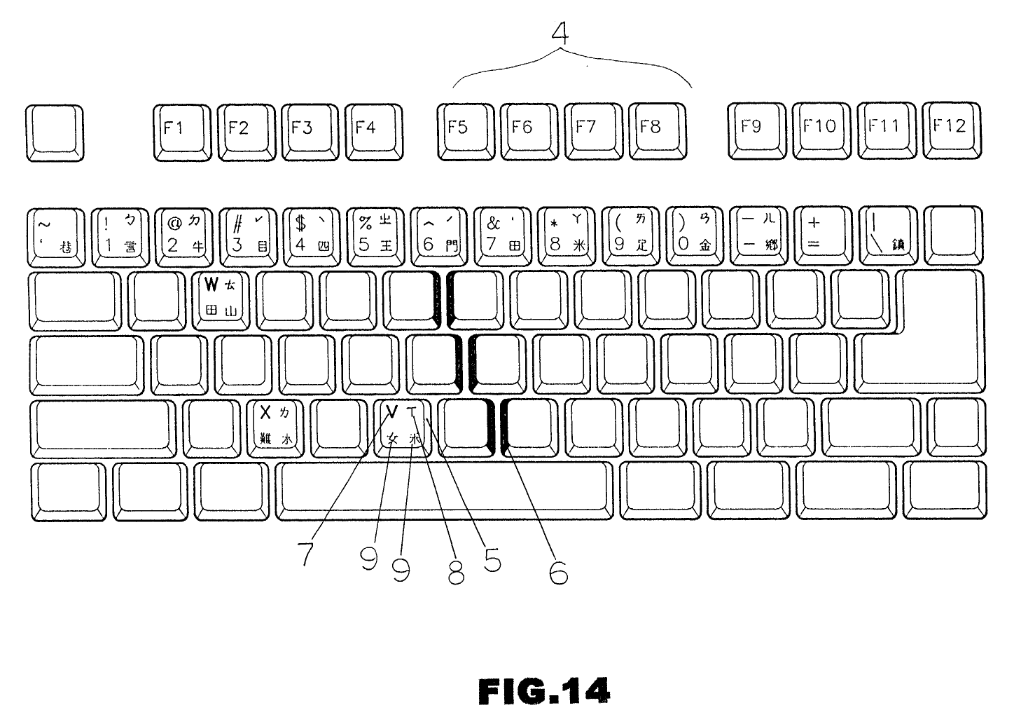

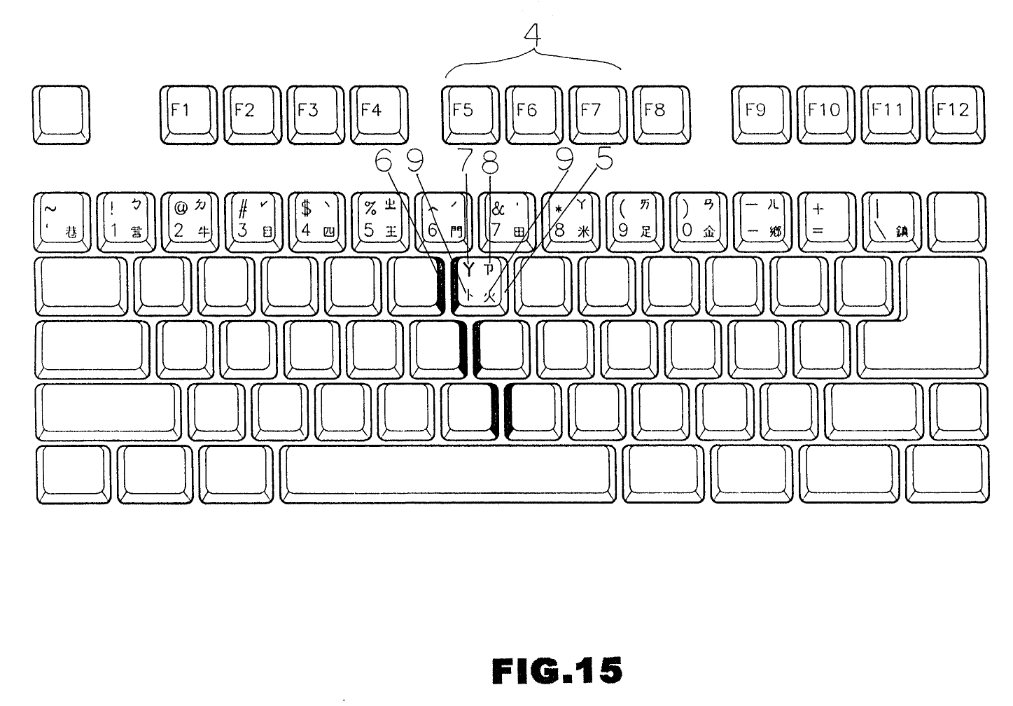

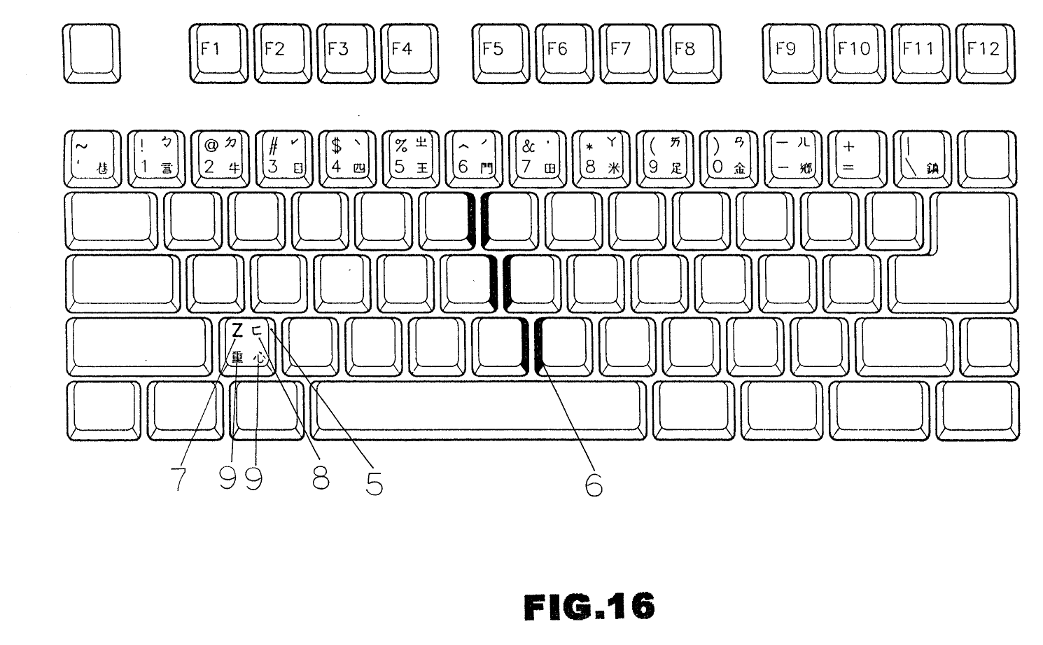

The third type of keyboards is divided into 7 key groups (5) as shown in Attachment 3, grouping the seven English letters of “A, B, C, D, E, F, and G” as a group and arranging these seven keys with a same color (as shown in FIG. 5), the nine English letters of “H, I, J, K, L, M, N, O, and P” as another group with another color (as shown in FIG. 6), the four English letters of “Q, R, S, and T,” as another group with another color (as shown in FIG. 7), the English letter “U” as another group with another color (as shown in FIG. 13), the three English letters of “V, W, and X” as another group with another color (as shown in FIG. 14), the English letter “Y” as another group with another color (as shown in FIG. 15), and the English letter “Z” as another group with another color (as shown in FIG. 16).

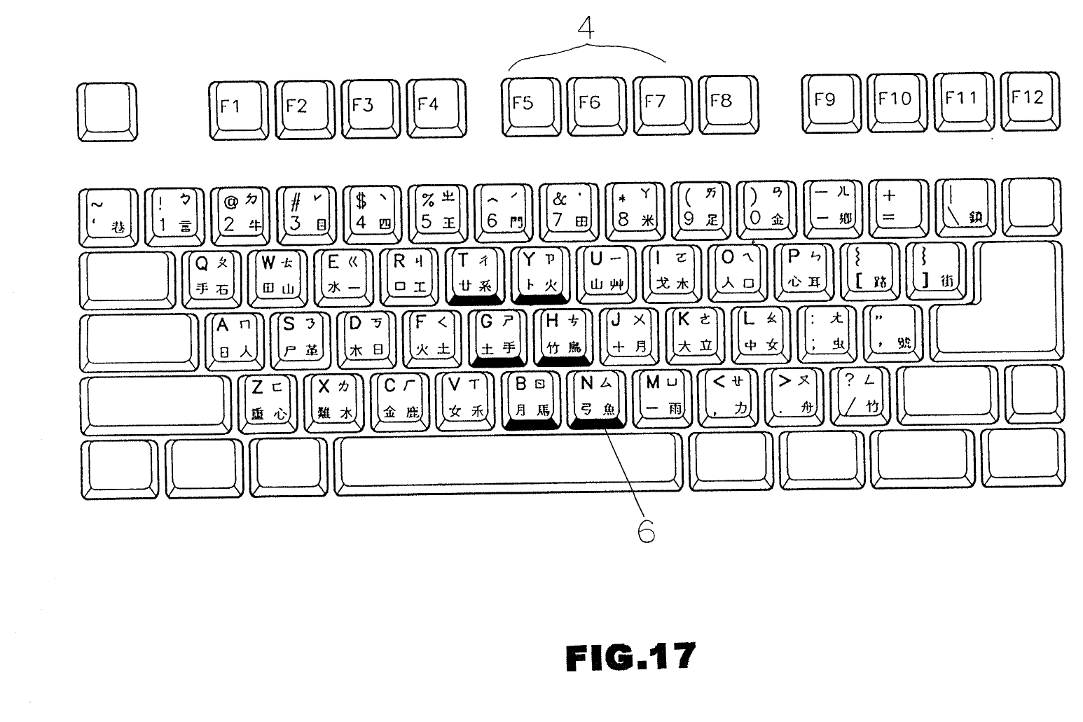

Please refer to FIG. 17, which shows a partition line 6 in a predetermined color on the lower lateral side of the three keys “T, G, and B” and the lower lateral side of the three keys “Y, H, and N”, and the partition line 6 obviously uses the keys “T, G, and B” and the keys “Y, H, and N” as boundary to partition the left hand area and the right hand area, and such design facilitates the identification for the jurisdiction area of input by left and right hands, and prevents the confusion of inputting by left or right hand and attains the effect of avoiding typographical mistakes.

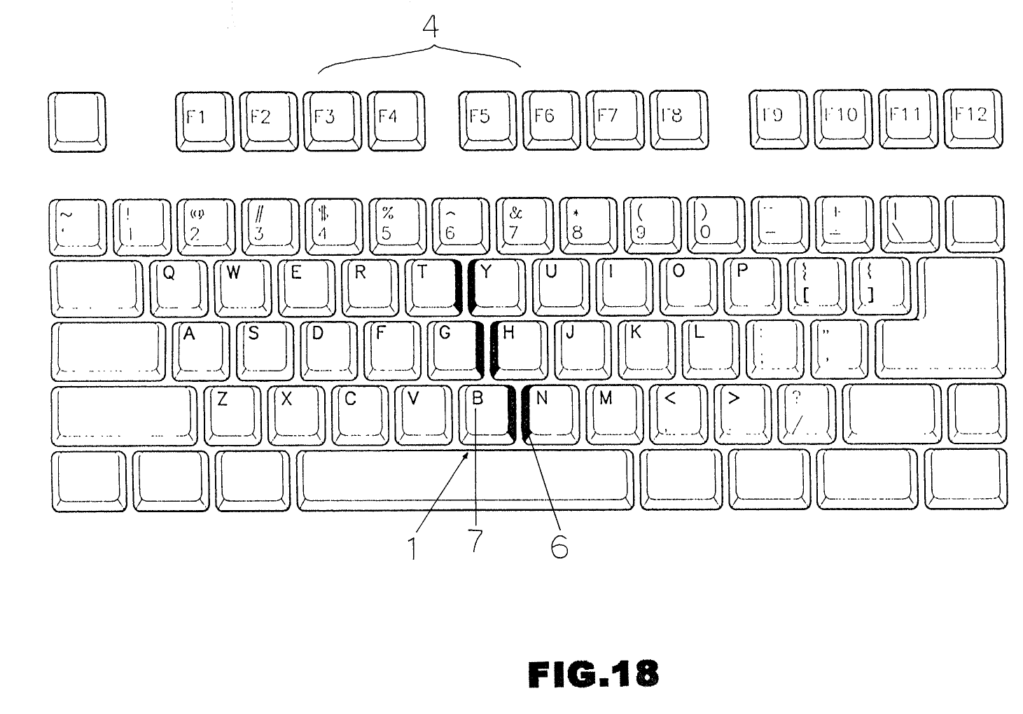

Please refer to FIG. 18, which shows the planar diagram of position layout for the English keyboard according to the present invention.

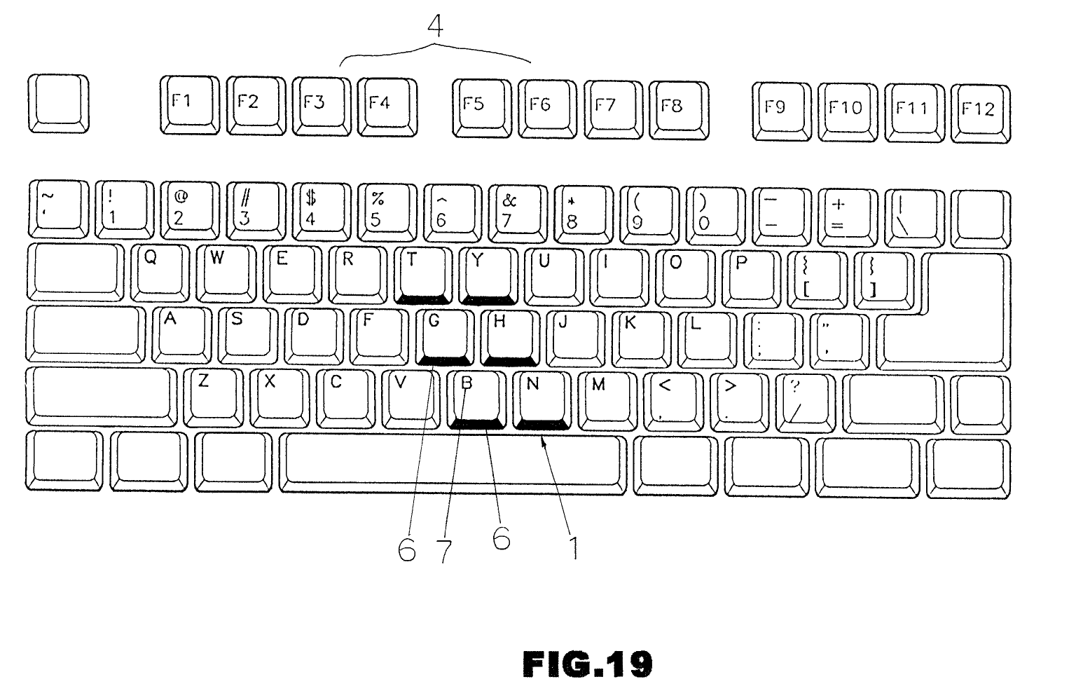

Please refer to FIG. 19, which shows the position of the partition line on the keyboard that divides the press keys into tow jurisdiction areas for the input by left and right hands according to another embodiment of the present invention.

In summation of the above description, the present invention herein enhance the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A computer keyboard structure, comprising a plurality of press keys with colors being made of soft elastic material, and the colored soft elastic press keys being classified into a plurality of key groups, each key group having a different color.

2. A computer keyboard structure as claimed in claim 1, wherein said keyboard comprising twenty six English letters which are divided into three types of grouping, wherein the first type comprising of four key groups, and the surface of each press key is grouped with colors and is made of a soft elastic material, such that the seven English letters of “A, B, C, D, E, F, and G” are grouped as a group and with a same color, the nine English letters of “H, I, J, K, L, M, N, O, and P” as another group with another color, the four English letters of “Q, R, S, and T” as another group with another color, and the six English letters of “U, V, W, X, Y, and Z” as another group with another color.

3. A computer keyboard structure as claimed in claim 2, wherein the second type of said keyboards is divided into 5 key groups and the surface of each press key is grouped with colors and is made of a soft elastic material, such that the seven English letters of “A, B, C, D, E, F, and G” are grouped as a group and these seven keys are arranged with a same color, the seven English letters of “H, I, J, K, L, M, and N” as another group with another color, the four English letters of “O, P, Q, and R,” as another group with another color, the six English letters of “S, T, U, V, W, and Y” as another group with another color, and the two English letters of “Z and X” as another group with another color.

4. A computer keyboard structure as claimed in claim 2, wherein the third type of said keyboards is divided into 7 key groups and the surface of each press key is grouped with colors and is made of a soft elastic material, such that the seven English letters of “A, B, C, D, E, F, and G” are grouped as a group and these seven keys are arranged with a same color, the nine English letters of “H, I, J, K, L, M, N, O, and P” as another group with another color, the four English letters of “Q, R, S, and T,” as another group with another color, the English letter “U” as another group with another color, the three English letters of “V, W, and X ” as another group with another color, the English letter “Y” as another group with another color, and the English letter “Z” as another group with another color

5. A computer keyboard structure, having a partition line in a predetermined color being disposed below the lateral side of the three keys with letters “T, G, and B” and below the lateral side of the three keys with letters “Y, H, and N”.
